(19) United States
(12) Patent Application Publication
(10) Pub. No.: US 2003/0169249 A1
(43) Pub. Date: Sep. 11, 2003

(54) Method and apparatus for automatically presenting information on a display

(75) Inventors: Kuni Masuda, Cupertino, CA (US); Joe Miseli, San Bruno, CA (US)

Correspondence Address: Brian M Berliner Esq, O'Melveny & Myers LLP, 400 South Hope Street, Los Angeles, CA, 90071-2899, US

(73) Assignee: Sun Microsystems, Inc.

(21) Appl. No.: 10/096,348

(22) Filed: Mar. 11, 2002

(51) Int. Cl. G09G 5/00

(52) U.S. Cl. 345/211

(57) ABSTRACT

Methods and apparatus are presented for presenting information on a display. In one aspect, information may be presented on a display after power up, and prior to the display being placed in a sleep mode. Additionally, the disclosure provides for detecting whether video has been applied to the display, and displaying a corresponding error message in no applied video has been detected. The disclosure further provides for determining whether a video error exists with the applied video, and displaying a corresponding error message if a video error is detected.

### BACKGROUND

1. Field of the Disclosure

The disclosure relates generally to automatically displaying information on displays such as computer monitors.

2. The Prior Art

Background

As LCD displays have become more sophisticated and less expensive, their use is becoming more common. Additionally, LCD displays are becoming thinner, as are the housings in which the LCD screens are being installed. Consequently, there may not be room on the bezel surrounding the LCD on which to place information such as manufacturer information and logos.

### BRIEF DESCRIPTION OF THE DRAWING FIGURES

FIG. 1 is a front view of a LCD display suitable for use with this disclosure;

FIG. 2 is a bottom view of a LCD display suitable for use with this disclosure;

FIG. 3 is a block diagram of a thermal management system configured in accordance with the teachings of this disclosure; and

FIG. 4 is a flow diagram of a thermal management system configured in accordance with the teachings of this disclosure.

FIG. 5 is a flow diagram of a method of presenting error messages on a display in accordance with the teachings of this disclosure.

### DETAILED DESCRIPTION

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

This disclosure may relate to data communications or processing. Various disclosed aspects may be embodied in various computer and machine readable data structures. Furthermore, it is contemplated that data structures embodying the teachings of the disclosure may be transmitted across computer and machine readable media, and through communications systems by use of standard protocols such as those used to enable the Internet and other computer networking standards.

The disclosure may relate to machine readable media on which are stored various aspects of the disclosure. It is contemplated that any media suitable for retrieving instructions is within the scope of the present disclosure. By way of example, such media may take the form of magnetic, optical, or semiconductor media, and may be configured to be accessible by a machine as is known in the art.

Various aspects of the disclosure may be described through the use of flowcharts. Often, a single instance of an aspect of the present disclosure may be shown. As is appreciated by those of ordinary skill in the art, however, the protocols, processes, and procedures described herein may be repeated continuously or as often as necessary to satisfy the needs described herein. Accordingly, the representation of various aspects of the present disclosure through the use of flowcharts should not be used to limit the scope of the present disclosure.

Exemplary embodiments of disclosed apparatus and methods may be disclosed herein. The word “exemplary” is used exclusively herein to mean “serving as an example, instance, or illustration.” Any embodiment described as an “exemplary embodiment” is not to be construed as necessarily preferred or advantageous over other embodiments described herein.

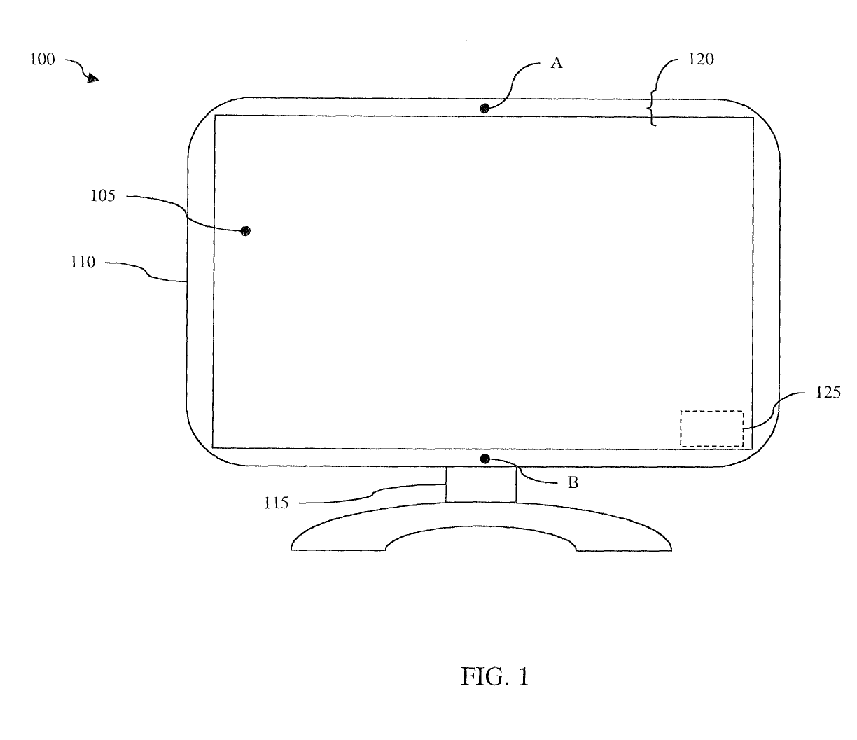

FIG. 1 is front view of a display 100 suitable for use with this disclosure. For illustrative purposes, the display 100 is shown as being an LCD screen, though other types of displays may be used in this disclosure, such as CRT-based displays or plasma-based displays.

The display 100 includes a screen 105 disposed within a housing 110, which may be mounted on a base 115. The area 120 between the outermost edges of the housing 110 and the screen 105 is referred to herein as the bezel 120. Typically, manufacturers of displays will place information such as logos and the like at locations A and B on the bezel 120. However, as LCD screen technology has become more advanced, manufacturers have been able to reduce the bezel area, resulting in a more pleasing appearance.

As a result, the areas A and B have become too small to put information or graphics of any size or substance within.

The display 100 includes circuitry 125 containing a processor, memory, and associated circuitry as is known in the art for operating the display 100 in accordance with the teachings of this disclosure. The display 100 will also include connectors and circuitry (not shown) known in the art for interfacing with sources of video, such as computers.

The present disclosure relates methods and apparatus for electronically presenting information on the screen 105 for viewing by a user. The information may include manufacturer's information, such as logos and the like, as well as system status information such as error information.

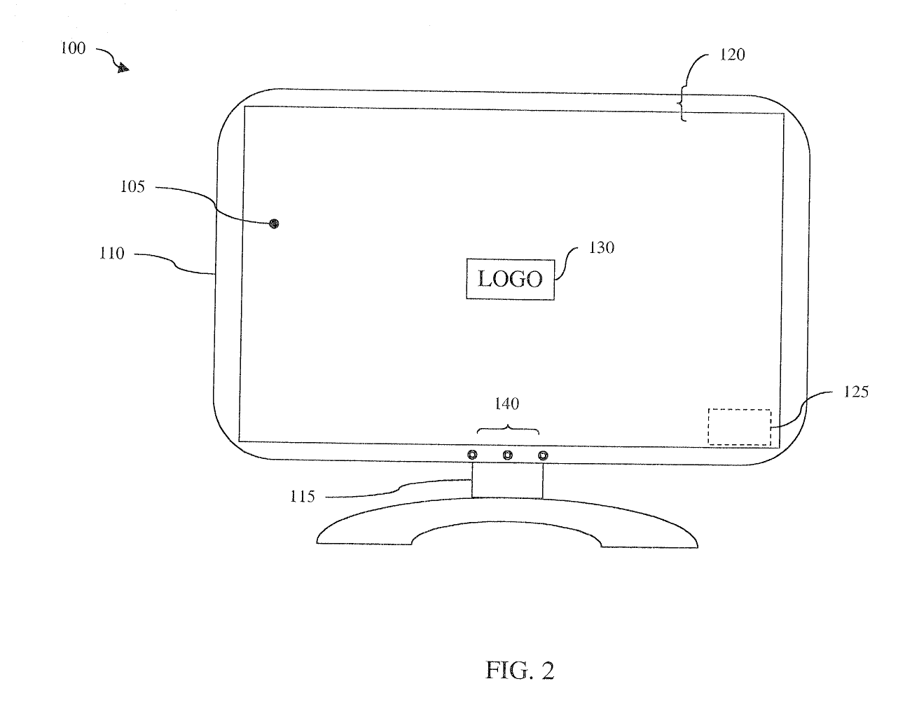

FIG. 2 is a front view of a display 100 configured in accordance with various aspects of this disclosure. The display 100 of FIG. 2 includes information 130 being displayed on the screen 105. In accordance with the teachings of this disclosure, the information 130 is displayed using the circuitry 125 without need for input from an external video source. The images and information to be displayed may be stored in, and retrieved from, the circuitry 125.

Additionally, the information 130 is displayed only when certain criteria or conditions are met. These criteria are chosen to maximize the presentation of information to the user so as to compensate for the lack of area on the bezel 120. The display of the information 130 is also chosen so as to minimize interference with the video desired to be observed by the user.

In a first aspect, the information 130 is displayed on the screen 105 prior to the lockup of the actual video to be displayed. For example, this may result in the information 130 being displayed for approximately 2 seconds prior to the display 100 receiving, processing, and displaying the received video signal. Thus, the user will be presented with manufacturer information such as the make or model of the display on startup, thus increasing the manufacturer's presence to the user.

A second aspect of FIG. 2 occurs prior to the time the display 100 enters a sleep mode. It is contemplated that the information 130 maybe displayed for a user-defined amount of time prior to the display 100 entering the sleep mode. The user may enter or change the duration of the information 130 display through the use of a On-Screen Display (OSD) as is known in the art.

A further aspect of FIG. 2 occurs when the display 100 is being presented for public display such as at a trade show or in a retail environment. In these types of situations, the lack of area on the bezel 120 may hinder the manufacturer's ability to create brand awareness. In this case, it is contemplated that the information 130 may be displayed at the activation of special “secret” keystrokes intended for use by marketing personnel. For example, it is contemplated that the display 100 will include a set of control buttons 140 for the normal control and operation of the display. By invoking a predetermined series or combination of the buttons 130, a user may put the screen into a perpetual sleep mode, whereby the information 130 will be displayed. For example, the user may press a predetermined set of buttons for a set time to invoke this marketing aspect.

In this kiosk aspect or mode, the information 130 may be displayed on the screen 105 by periodically moving the information about the screen 105 to minimize burn-in as well as attracting attention.

The kiosk mode may remain in effect until a predetermined combination of buttons 130 are pressed, or the display 100 is powered down and restarted. It is desirable that other button operations have no effect on the information 130 display, so as not to effect the kiosk operation of this aspect. Since the information 130 is generated without the need for an external source, the display 130 may operate in a kiosk mode with only the requirement of a power source.

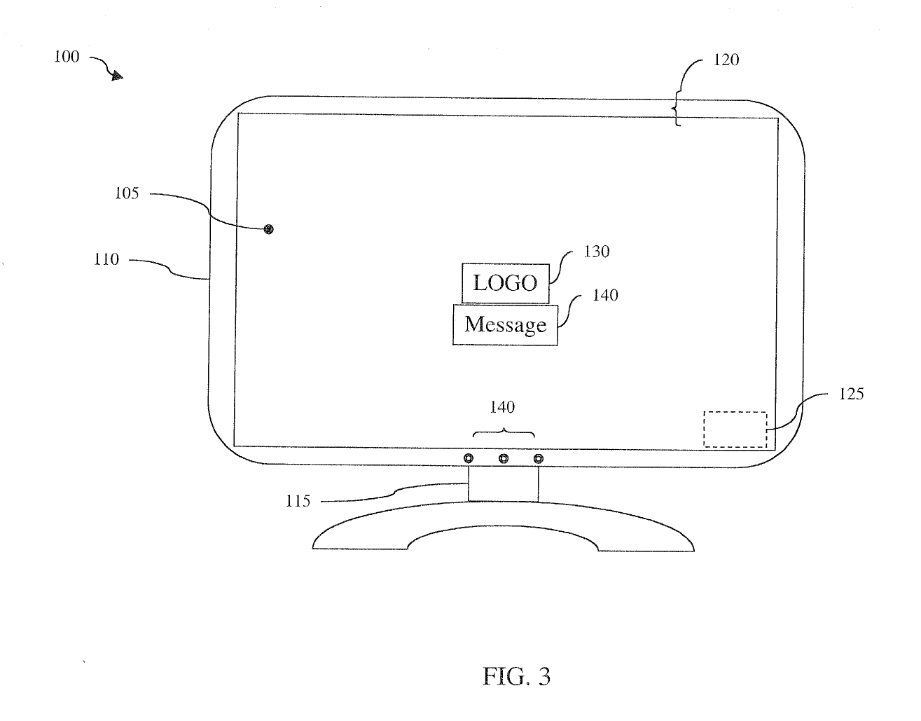

FIG. 3 is a front view of a display 100 configured in accordance with further aspects of this disclosure. FIG. 2 shows that in addition to the information 130, an additional message may be displayed to the user.

In one aspect of FIG. 3, the message 140 may correspond to a predetermined condition resulting in no video being displayed. Thus, the display 100 may sense a condition, and display a message responsive to the sensed condition. For example, if no video is present (such as if no input cables are connected to the display), the display 100 may present the user with a message such as “Check Cables” or “No Signal Detected” in the message area 140.

In a further aspect, the display 100 may be configured to sense an error condition in the applied video stream, and present a message 140 responsive to the error condition. Thus, if the applied video is in a format inappropriate for the display, the message 140 may indicate to the user the nature of the incompatibility. For example, messages may be displayed indicating that the applied video is of an inappropriate resolution, cannot be synced, or is out of range. As message space may be limited, error codes may be displayed within the message 140 that may be referenced to further troubleshoot the problem.

In all aspects of FIG. 3, the manufacturer's logo 130 may also be displayed proximate to the message 140.

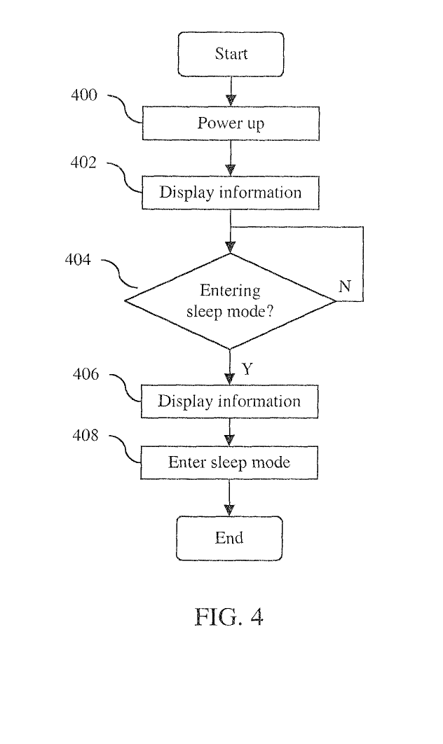

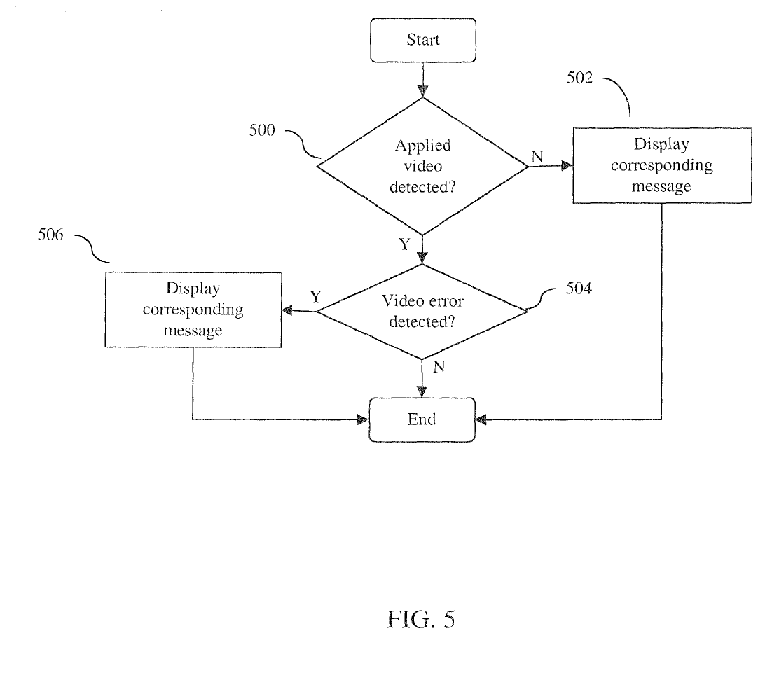

FIG. 4 is a flow diagram of a method of presenting information on a display in accordance with the teachings of this disclosure. The methods disclosed in FIGS. 4 and 5 may be performed by the display as disclosed in the various aspects disclosed herein.

The process starts in act 400, where the display powers up. After powering up, the display may present information in act 402. The information may be displayed for a brief period of time prior to the syncing of any applied video.

The process may then move to query 404, where the display will wait for the onset of a sleep command. When a sleep cycle is detected, the display may present information in act 406 immediately prior to the sleep cycle. As mentioned above, the information may be displayed for a period of time definable by the user.

After having displayed the information for the desired amount of time, the display may enter the sleep cycle in act 408.

It is contemplated that if the display is awaken from the sleep cycle, the process may move either to act 402 (where the information will be displayed prior to video re-synching, or directly back to the query 404.

FIG. 5 is a flow diagram of a method of presenting error messages on a display in accordance with the teachings of this disclosure. The process begins in query 500, where the display determines whether any applied video can be detected. If no video is detected, then a corresponding message may be displayed to the user in act 502, where the content of the message may correspond to a particular condition detected by the display. The message displayed in act 502 may also be display with a logo or other information as disclosed herein.

If there is applied video detected, then the process moves to query 504, where it is determined whether there is an error with the applied video. As disclosed herein, the types of errors that may be detected include inappropriate formats or resolutions, errors with syncing, or errors with the video being out of range. If an error is found, a message corresponding to the error found is displayed in act 506.

If no error is found, the process may end.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

What is claimed is:

1. A method of presenting information on a display comprising:
displaying information on a display for a first predetermined amount of time after said display powers up;
determining whether said display is being placed in a sleep mode; and
presenting said information for a second predetermined amount of time prior to said display entering said sleep mode if said display is being placed in said sleep mode.

2. The method of claim 1, further including the act of detecting whether video has been applied to said display, and displaying a corresponding error message in no applied video has been detected.

3. The method of claim 2, further including the act of determining whether a video error exists with said applied video, and displaying a corresponding error message if a video error is detected.

4. The method of claim 2, wherein the content of said corresponding message corresponds to a particular detected condition.

5. The method of claim 3, wherein the content of said corresponding message corresponds to a particular detected condition.

6. The method of claim 4, wherein said corresponding error message further includes said information.

7. The method of claim 6, wherein said information comprises a logo.

8. The method of claim 4, wherein said particular detected condition consists on no video cables being attached to said display.

9. The method of claim 5, wherein said particular detected condition is chosen from the group consisting of an inappropriate formats, an inappropriate resolutions, errors with syncing, and out of range video.

10. A program storage device readable by a machine, tangibly embodying a program of instructions executable by the machine to perform a method of presenting information on a display, said method comprising:
displaying information on a display for a first predetermined amount of time after said display powers up;
determining whether said display is being placed in a sleep mode; and
presenting said information for a second predetermined amount of time prior to said display entering said sleep mode if said display is being placed in said sleep mode.

11. The device of claim 10, further including the act of detecting whether video has been applied to said display, and displaying a corresponding error message in no applied video has been detected.

12. The device of claim 11, further including the act of determining whether a video error exists with said applied video, and displaying a corresponding error message if a video error is detected.

13. The device of claim 11, wherein the content of said corresponding message corresponds to a particular detected condition.

14. The device of claim 12, wherein the content of said corresponding message corresponds to a particular detected condition.

15. The device of claim 14, wherein said corresponding error message further includes said information.

16. The device of claim 15, wherein said information comprises a logo.

17. The device of claim 13, wherein said particular detected condition consists on no video cables being attached to said display.

18. The device of claim 14, wherein said particular detected condition is chosen from the group consisting of an inappropriate formats, an inappropriate resolutions, errors with syncing, and out of range video.

19. An apparatus for presenting information on a display comprising:
means for displaying information on a display for a first predetermined amount of time after said display powers up;
means for determining whether said display is being placed in a sleep mode; and
means for presenting said information for a second predetermined amount of time prior to said display entering said sleep mode if said display is being placed in said sleep mode.

20. The apparatus of claim 19, further including the act of detecting whether video has been applied to said display, and displaying a corresponding error message in no applied video has been detected.

21. The apparatus of claim 20, further including the act of determining whether a video error exists with said applied video, and displaying a corresponding error message if a video error is detected.

22. The apparatus of claim 20, wherein the content of said corresponding message corresponds to a particular detected condition.

23. The apparatus of claim 21, wherein the content of said corresponding message corresponds to a particular detected condition.

24. The apparatus of claim 22, wherein said corresponding error message further includes said information.

25. The apparatus of claim 24, wherein said information comprises a logo.

26. The apparatus of claim 22, wherein said particular detected condition consists on no video cables being attached to said display.

27. The apparatus of claim 23, wherein said particular detected condition is chosen from the group consisting of an inappropriate formats, an inappropriate resolutions, errors with syncing, and out of range video.
